(19) United States
(12) Patent Application Publication
(10) Pub. No.: US 2011/0075924 A1
(43) Pub. Date: Mar. 31, 2011

(54) COLOR ADJUSTMENT

(75) Inventors: Prarthana Shrestha, Eindhoven (NL); Dragan Sekulovski, Eindhoven (NL); Mauro Barbieri, Eindhoven (NL); Johannes Weda, Eindhoven (NL); Ramon Antoine Wiro Clout, Eindhoven (NL)

(73) Assignee: KONINKLIJKE PHILIPS ELECTRONICS N.V., EINDHOVEN (NL)

(21) Appl. No.: 12/995,478

(22) PCT Filed: Jun. 16, 2009
(86) PCT No.: PCT/IB2009/052557

§ 371 Date: Dec. 1, 2010

(30) Foreign Application Priority Data
Jun. 17, 2008 (EP) 08158435.1

(51) Int. Cl. G06K 9/00

(52) U.S. Cl. 382/167

(57) ABSTRACT

To adjust colors in an input image (II) to colors of a reference image (RI), matching reference points (RP) are provided in the input image (II) and the reference image (RI), dominant colors of the matching reference points (RP) are determined (10, 20), and the colors in the input image (II) are transformed (30, 40) based on the dominant colors of the matching reference C points to obtain an output image (OI).

### FIELD OF THE INVENTION

The invention relates to a method and device for color adjustment.

### BACKGROUND OF THE INVENTION

Various professional or semi-professional applications such as stereo-photography, surveillance, TV productions, wedding or sports videography use multiple cameras. With the increase in availability and affordability of digital still and video cameras, events such as parties, museum visits and holidays are also recorded by many people. This provides a large pool of content, which can be exchanged or combined for a better representation of the event.

The process of combining different camera recordings includes frame accurate time synchronization, evaluation of the content and selection of the segments containing the best evaluated content. The expected result is a combined picture or a video, which appear seamless and uniform like it is captured from a single camera.

Different cameras offer different recording quality based on the hardware and software characteristics. The automatic camera settings produce different results on different cameras when recording under the same conditions. Users can also customize their setting like white balance, shutter speed, etc. This results in different color reproduction of an image or video, although recorded at the same time, space and physical conditions. The difference can be subtle for individual cameras, but when the recordings are put together the scene's overall effect is distracting.

In professional productions the cameras are synchronized by tuning different camera parameters to reproduce the same and natural color. During post-processing, software editors such as Adobe Premiere Pro, Adobe Photoshop, Final Cut Pro offer tools to correct the discrepancies by manually selecting different colors in one clip as a reference and adjusting the color from other clips according to the reference. In order to achieve a desirable match a user has to try several parameters such as highlight, mid-tones, shadows, brightness, contrast, etc. that is very time consuming and in many cases almost impossible.

### SUMMARY OF THE INVENTION

It is, inter alia, an object of the invention to provide an improved color adjustment. The invention is defined by the independent claims. Advantageous embodiments are defined in the dependent claims.

In accordance with the present invention, colors in an input image are adjusted to colors of a reference image by providing matching reference points in the input image and the reference image, determining dominant colors of the matching reference points, and transforming the colors in the input image based on the dominant colors of the matching reference points to obtain an output image.

The invention is based on comparing representative points from the two images, using the dominant color at each point and not on the color value of the point itself. The advantage of using the dominant color is that it is more robust to noise than the individual pixel values. The dominant colors of matching points of the two images are used to calculate a transformation (e.g. linear) that is applied to the image that has to be color corrected. The invention can be made completely automatic or semi-automatic according to user preference. In a preferred embodiment, it does not require any additional information like camera settings and light conditions.

These and other aspects of the invention will be apparent from and elucidated with reference to the embodiments described hereinafter.

### BRIEF DESCRIPTION OF THE DRAWINGS

FIG. 1 illustrates a first embodiment of the invention.

### DESCRIPTION OF EMBODIMENTS

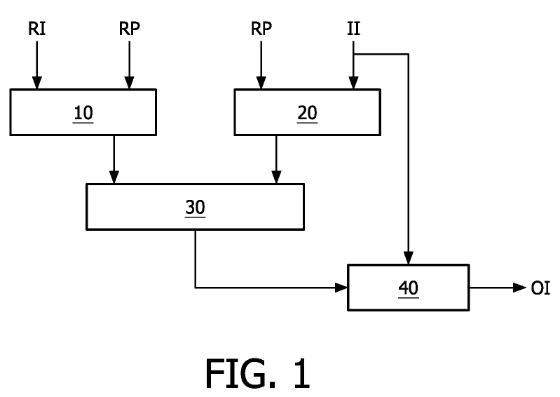

FIG. 1 illustrates a semi-automatic embodiment of the invention. In this approach, a user provides not only the reference image RI, and the input image II that needs to be adjusted to the reference image RI, but also matched pairs of representative points RP. For both the reference image RI and the input image II, in blocks 10, 20 the dominant colors at the representative points are calculated. This gives color information at the pixel that is very robust against color noise. In a preferred embodiment, the mean-shift algorithm of the article “Mean Shift Analysis and Applications”, D. Comaniciu and P. Meer, in Proceedings ICCV (2) 1999, pp. 1197-1203, is used to calculate the dominant color for each of the representative points. We define the locally dominant color as the color for which the estimated density (estimated, for example, by a histogram) is locally dominant in a certain neighborhood. Another way of seeing this is that the dominant color in a part of a color space is the most typical representative of that part of the color space. The way we compute the local dominant color starting from a pixel color is by ascent on the density slope until we come to a local dominant color. The preferred algorithm, the mean shift, does this without the need of computation of the histogram or any other density estimate of the whole space. The algorithm starts at the color value for the selected pixel, estimates the density at the point, estimates the gradient of the density and jumps toward a point of higher density. The estimation is done using a radial kernel. In our preferred implementation we use a Gaussian kernel with size of 5 ΔE (standard distance in CIE Lab color space).

In a straightforward embodiment, in block 30, a color set difference is calculated. In case of 1D color difference, the differences can be computed as a standard arithmetic difference or a ratio between the color coordinates of the matching dominant colors in a given color space. For example, the difference in linear RGB of two colors c and d in the dominant color sets can be computed as c−d. The difference in dominant color set is then used in block 40 in the color adjustment of the input image II image by means of a linear transformation. For example, if a pixel in the test image has color a, it is transformed into a+(c−d). The output image OI is a version of the input image II adjusted to match the colors of the reference image RI. However, the invention is not limited to this straightforward embodiment, as in principle any transformation function (e.g. linear, quadratic) based on the matching points in the dominant color sets using a fitting criterion (e.g. least square) could be used, and in such a transformation there may be no need for a color set difference calculation 30 as a separate step.

In a second embodiment, not shown, the matching reference points RP do not need to be provided by a user but will be detected automatically in the reference image RI and the input image II. To this end, at least one reference point RP is selected belonging to a representative color from the regions that cover visually salient areas in input images, such as areas that are large, and/or in focus, and/or foreground or background or prominent objects. Such regions and objects are computed using image segmentation, foreground/background classification techniques, or object detection algorithms. In order to find the same color regions in the two input images, the representative points and their corresponding dominant colors should be matched. Therefore, a mapping technique is used on the dominant colors from the input images based on their spatial and color information in the following manner. The whole image is processed and all the local dominant colors extracted. The mapping is implemented as a search in the space of possible mappings from one set to the other that minimizes the least fitting error of a transformation of a certain type (for example a linear transformation given by a 3×3 matrix). The transformation can be done in a number of color spaces, but our preferred implementation, as mentioned before, uses the source RGB, which is simple and fast and still provides good results on our test data.

The invention can be applied in an application in which videos recordings of an event from multiple cameras are combined into a summary. The invention can also be applied to correct badly illuminated photographs. In general, the invention can be applied for color synchronization of images from multiple cameras with both automatic and semi-automatic means. It is suitable for hardware implementation in mixers, where videos from different cameras are recorded for online or offline editing. The implementations are useful for editing video/photo, making panorama images or creating video mash-ups from different recordings. In case of video, key-frames from a shot or a scene can be used as input images to calculate a transformation function that is then applied to all the frames (of the same shot/scene).

In summary, both professional and semi-professionals use multiple cameras for different purposes such as stereo-photography, surveillance, TV productions, and sports videography. Many amateurs use cameras embedded in mobile phones or camcorders in social events like weddings, parties and vacations. An ideal video summary from such events would contain the best segments from different cameras. Similarly, an ideal photo collage or panorama would contain the photos that best represent the reality. However, different cameras reproduce different results of the same object due to difference in camera quality, settings and lighting conditions. Combining the recordings from different cameras requires color correction; otherwise the effect is patchy and very distracting. The existing tools require manual tuning of several parameters to achieve a desirable match. In a preferred embodiment of the invention, colors in two images are synchronized without requiring any additional data about camera settings and light conditions. The color offset between the images is calculated by the difference in dominant colors from the matching representative points. A linear transformation is then used to transform one image with respect to the other according to the offset value. An embodiment of the invention can be used to correct badly illuminated images at a location with the help of another image with desired illumination.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention may be implemented by means of hardware comprising several distinct elements, and/or by means of a suitably programmed processor. In the device claim enumerating several means, several of these means may be embodied by one and the same item of hardware. The mere fact that certain measures are recited in mutually different dependent claims does not indicate that a combination of these measures cannot be used to advantage.

1. A method of adjusting colors in an input image (II) to colors of a reference image (RI), the method comprising:
providing matching reference points (RP) in the input image (II) and the reference image (RI);
determining (10, 20) dominant colors of the matching reference points (RP); and
transforming (30, 40) the colors in the input image (II) based on the dominant colors of the matching reference points to obtain an output image (OI).

2. A method as claimed in claim 1, wherein said transforming step (30, 40) comprises:
calculating a color set difference between the dominant colors of the matching reference points (RP); and
adding said color set difference to colors of the input image (II) to obtain colors of the output image (OI).

3. A method as claimed in claim 1, further comprising the step of automatically detecting the matching reference points (RP) in the reference image (RI) and the input image (II).

4. A method as claimed in claim 3, wherein said automatically detecting step comprises:
selecting points that belong to a representative color from a visually salient area; and
mapping the selected points and their corresponding dominant colors to obtain pairs of matching representative points.

5. A device for adjusting colors in an input image (II) to colors of a reference image (RI), the device comprising:
means for providing matching reference points (RP) in the input image (II) and the reference image (RI);
means (10, 20) for determining dominant colors of the matching reference points (RP); and
means (30, 40) for transforming the colors in the input image (II) based on the dominant colors of the matching reference points to obtain an output image (OI).

6. A device as claimed in claim 5, wherein said transforming means (30, 40) are programmed for:
calculating a color set difference between the dominant colors of the matching reference points (RP); and
adding said color set difference to colors of the input image (II) to obtain colors of the output image (OI).

7. A device as claimed in claim 5, further comprising means for automatically detecting the matching reference points (RP) in the reference image (RI) and the input image (II).

8. A device as claimed in claim 7, wherein said means for automatically detecting the matching reference points (RP) are programmed for:
selecting points that belong to a representative color from a visually salient area; and
mapping the selected points and their corresponding dominant colors to obtain pairs of matching representative points.
